(19) United States
(12) Patent Application Publication
(10) Pub. No.: US 2009/0012892 A1
(43) Pub. Date: Jan. 8, 2009

(54) Financial product futures and system and method for trading such futures

(76) Inventor: Lucio Biase, New York, NY (US)

Correspondence Address: LUCIO BIASE, SUITE 711, 130 WEST 42ND STREET, NEW YORK, NY, 10036, US

(21) Appl. No.: 11/825,343

(22) Filed: Jul. 6, 2007

(51) Int. Cl. G06Q 40/00

(52) U.S. Cl. 705/37

(57) ABSTRACT

A method, system and financial product permitting trading of futures of OTC derivatives is provided.

This claims the benefit of U.S. Provisional Patent Application No. 60/818,575 filed Jul. 5 2006, which is hereby incorporated by reference herein.

The present invention generally relates to a system and method for trading financial products, as well as to those financial products, and more particularly to trading forwards and futures.

### BACKGROUND OF THE INVENTION

Perhaps the best known historical example of exchange traded forward/futures contracts is the 1634 deliverable tulip contracts of the Dutch markets. While forwards or futures transactions have been employed for hundreds of years, exchange traded options and derivatives are more recent; options and other derivatives on futures even more so.

Accepting physical delivery of the deliverable covered by a futures contract requires high transaction costs to cover the warehouse, transport, resources and personnel to accept delivery of the future's respective deliverable (ranging from cattle to butter or board lengths of lumber). Futures markets developed to permit people without the resources to accept deliver to still trade these asset classes. It is estimated that less than 0.40% of open interest traded on the New York Mercantile Exchange (NYMEX) goes to physical delivery, similarly speculative accounts—those that cannot accept physical delivery of a futures contract—registered with the National Futures Association (NFA) out number NFA registered hedge accounts—those that can accept delivery of the contracts.

OTC Derivatives are individually negotiated financial contracts where the value is derived from the change in value of a given underlying asset.

An example of an OTC derivative on Jul. 31, 2007 can be a call option to buy 10,000 euros (EUR) at 1.321 EUR/US dollars (i.e. for 13,210 USD) on Jul. 31, 2008. Depending on the current exchange rate, the value of the option will vary. The current exchange rate and the interest rates for Jul. 31, 2008 of both currencies determine the expected forward value of EUR/USD on Jul. 31, 2008, and thus the value of the option. If the strike price is equal to the expected forward value, i.e. 1.321 EUR/USD, the option is written “at the money” or 50% delta. There is a 50% probability that the option will be exercised, and 50% probability that it will not be. If the underlying value of EUR/USD increases by 1%, and the delta was 50%, the call option increases in value 1%*50% or 50 basis points. If the value of EUR/USD moves so that the above call option has a 75% delta, for each percent move of the underlying value of EUR/USD, the option increases in value 75 basis points.

The delta is thus the ratio comparing the change in the price of the underlying asset to the corresponding change in the price of a derivative.

As the interest rates in either currency or the underlying price moves, so will the delta.

Other OTC derivatives include puts (to sell at a certain strike price), swaps, credit derivatives and forwards. The process of settling, confirming and maintaining OTC derivative trades, where contracts can have over 100 variables, is complicated. Heavy documentation burdens include an International Swaps Dealer Association (ISDA) Master Agreement, CSA Agreements and individual trade confirms.

Unlike listed securities, OTC derivative instruments are individually negotiated between the two counterparties. Equity and bond markets such as the New York Stock Exchange and NASDAQ use cash settlement to pay for securities. They benefit from clearing houses to settle physical delivery of the security for cash. OTC derivatives however are confirmed individually and settled by the counterparties on both legs of the trade.

One OTC derivate, Credit Default Swaps (CDS), now eclipses the cash bond market from which it is derived. CDS are a cross between a put option on a bond triggered by a qualifying event of default and an insurance policy on the bond where the premiums are paid over the term of the contract. For example, Citibank owns $10 M USD face value or notional of Brazilian government 10 year debt. In a CDS contract, Citibank will pay another party, for example Deutsche Bank 300 basis points a year for five years ($300,000 USD/year) for Deutsche Bank to write protection on these bonds. In the event the bonds experience a qualifying event of default, Citibank will deliver to Deutsche Bank the bonds $10 M notional of bonds (often with a decreased or recovery value), in return for $10 M.

CDS offers investors better leverage to investors versus trading bonds. In this example, Deutsche Bank was able to have the equivalent of $10 M exposure without tying up investment funds worth the price of the $10 M bonds notional. They merely must pledge the collateral necessary to cover change in value.

Many clients refrain from trading CDS due to the heavy documentation and disclosure requirements mandated by each counterparty—ISDA, CSA and Individual Trade Confirmations; the back office resources required; and the difficulty of valuing and closing an off the run OTC trade.

While CDS has been traded for close to 15 years, the British FSA and the Fed have only recently addressed the basic issues inherent in this derivative market. In 2005 when the market was just $12.4 trillion it was estimated that 40% of outstanding trades were not confirmed and that confirmation could take up to two months. At the beginning of 2007, the percentage of unconfirmed CDS trades was roughly 20% taking up to one month to confirm. This backlog is substantial, while the time and percentages have halved, the size of the market has nearly tripled. Confirming these trades as they are currently traded and settled leads to risks, which are measured in the billions.

### SUMMARY OF THE PRESENT INVENTION

The present invention provides a method for trading futures on financial products comprising:

defining a reference financial product and providing a contract rate;

accepting a trade from a first party on a future where the deliverable is the reference financial product at the contract rate;

allocating a change in value of the future to the first party; and

resetting the contract rate for the first party as a function of the change in value.

The contract rate maybe for example a spread, forward points, or price.

The present invention also provides a method for trading futures on financial products comprising:

defining a reference financial product having and providing a delta at a predetermined level;

accepting a trade from a first party on a future where the deliverable is the reference financial product at the delta;

allocating a change in value of the future to the first party; and

resetting the price of the future for the first party as a function of the change in value.

The present invention also provides a trading platform comprising: a system for trading futures based on OTC derivatives; and stands between counterparties warehousing trades and managing collateral until delivery of the futures whether accelerated or scheduled.

The present invention further provides a financial product comprising; a future based on an OTC derivate.

### BRIEF DESCRIPTION OF THE DRAWINGS

An embodiment of the present invention will be described with respect to the following drawings in which:

FIG. 1a shows the open positions of participants before delivery in a tabular form.

FIG. 1a shows a diagram of the open positions of participants before delivery.

FIG. 2a shows the first example of settlement allocation whereby the matching engine takes delivery at fixing in a tabular form.

FIG. 2b shows the first example of settlement allocation in a diagram form whereby the matching engine takes delivery at fixing.

FIG. 3a shows the second example of settlement allocation whereby the matching engine steps out at delivery in a tabular form.

FIG. 3b shows the second example of settlement allocation in a diagram whereby the matching engine steps out at delivery.

FIG. 4a shows the third example of settlement allocation that is a hybrid of the first two settlement allocations of FIGS. 2 and 3 in a tabular form.

FIG. 4b shows the third example of settlement allocation in a diagram that is a hybrid of the first two settlement allocations of FIGS. 2 and 3.

FIG. 5 shows the Current Trading Process:

FIG. 6 shows the Current Trading Pile-Up:

FIG. 7 shows the Advent of Matching Engine

FIG. 8 shows the Matching Engine converting open positions to ATM & Cash Flow

FIG. 9 shows the Matching Engine Consolidating Positions

### DETAILED DESCRIPTION

The present invention provides a system and method, as well as a series of financial products, to facilitate trading of various asset classes. Options, swaps and currencies may be traded via “synthetic” futures, whereby the deliverable is the derivate obligation.

The present invention includes: (a) a series of OTC surrogate financial products that can be traded with ease and liquidity and (b) the order matching, trading, settlement, risk and P&L reporting systems that support these products.

This approach overcomes the “liquidity hurdle” that has prevented many OTC derivatives and options from developing into exchange traded securities and has applications across many asset classes including but not limited to: Currency Spot, Forward and Options; Equity Options, including but not limited to Variance Swaps; Interest Rate Swaps; and Credit Derivative Transactions.

In synthetically securitizing these derivative transactions, current Bid/Ask spreads of thousands of dollars can begin to approach zero, settlement costs can decrease from hundreds of dollars to double digits and settlement lags can be diminished, to the point of providing almost instant confirmation and settlement.

The system of the present invention allows for programmed trading of the OTC asset classes, which are standardized. The standardization allows for OTC positions to net and not aggregate, saving participants' balance sheet.

The liquidity hurdle is a legacy of exchange traded options trading at a price—not at a delta or ATM—how OTC markets are quoted. Opening an option trade at a price is the same as entering an off-the-run position, it is not quoted in the standard, “on-the-run” market. To unwind an off-the-run position is costly and takes much more time to trade, value and confirm.

OTC asset classes can be opened to low latency programmed trading and lower bid/asks, seen for example in equities markets. The unique standardization and settlement mechanism of this invention predefines valuation models, counter party position matrix, accelerated deliver mechanism, inputs, assumptions, trade variables defined at delivery, allowing for employment of an Electronic Clearing Network (ECN) to these asset classes, linking disjoint trading platforms and market participants.

By agreeing on all terms of the trade except for the contract rate and/or ultimate counterparty, and delaying settlement to a given date (the futures derivatives delivery date unless there is a qualifying event that accelerates delivery), counterparties can be in and out of trades and net their position and have a fixing to define contract. This system of trading, quoting and settlement also allows for these instruments to become exchange traded.

The present invention provides for quoting derivates contracts at the money (ATM), at a defined delta or where only the counterparty being faced is defined at delivery.

Risk, P&L and collateral of the positions of the contracts being offered are defined by sector, rating, market capitalization, geographic distribution and permutations thereof in a electronic file format.

While this platform enables the sellside to be both a price maker and a taker, unlike the exchange surrogates, sellside's can maintain “brand” and buyside can monetize relationships through our Request for Quote (RFQ). Similar to trading listed securities, Sellside can place Iceberg, Limits, OCO/OSO and Stop Orders, while not giving away, their size, direction or level, unprecentdented across OTC markets. While most are familiar with the trading screens offered by listed listed securities, this system will allow participants view the following in realtime: Positions & Limits, Risk, Collateral Required, Order Status, and Order Depth.

Liquidity is pooled through the system using a matching engine with “a delta neutral” collateral warehouse:

OTC transactions are historically traded voice brokered, via email or other forms of electronic communication or on isolated electronic trading platforms. As such, participants have to employ a market maker to receive a price level or execute a trade. Both buyside and seaside trading activity is capped by their sales' coverage, counterparty agreements and isolated pools of liquidity. This invention's financial products and settlement mechanism makes those issues obsolete. By forming a “credit limit matrix” (that may be defined at the various participant level per product or group of products, see Tables 1 and 2) and defining the process of delivery allocations, participants can trade to the capacity of the credit limits afforded to them by the other members of the consortium, regardless of who is on the other side of the trade. This affords all participants excellent pools of liquidity.

There are four types of participating accounts:

TABLE 1

| Type of Account | Abbreviation | Functionality |
|---|---|---|
| Clearing Consortium | CCA | Price Maker |
| Account | | Price Taker |
| | | Trades on behalf of Client |
| | | Can initiate and receive RFQ |
| Direct Dealing: Sellside | DDS | Price Maker |
| | | Price Taker |
| | | Can initiate and receive RFQ |
| Direct Dealing: Buyside | DDB | Price Taker |
| | | Price Maker |
| | | Can initiate RFQ |
| Primed Buyside Account | PBA | Price Taker |
| | | Price Maker (one sided market |
| | | at the sole discretion of the |
| | | CCA) |
| | | Can initiate RFQ |

Credit Extended to a counterparty is listed across, and credit received are the titles or the rows.*

TABLE 2

| | PBA | | | | | | PBB | PBA |
|---|---|---|---|---|---|---|---|---|
| | (c) | CCA (b) | DDS (b) | DDS (a) | DDB (a) | CCA (a) | (b) | (a) |
| PBA (c) | | 50,000 | — | — | — | 75,000 | — | — |
| CCA | 50,000 | | 2,000,000 | 5,000,000 | 10,000,000 | 20,000,000 | 200,000 | 100,000 |
| (b) | | | | | | | | |
| DDS (b) | — | 1,500,000 | | 3,000,000 | 2,000,000 | 6,000,000 | — | — |
| DDS (a) | — | 5,000,000 | 3,000,000 | | 500,000 | 5,000,000 | — | — |
| DDB | — | 10,000,000 | 2,000,000 | 500,000 | | 1,000,000 | — | — |
| (a) | | | | | | | | |
| CCA (a) | 75,000 | 20,000,000 | 6,000,000 | 5,000,000 | 1,000,000 | | 350,000 | 200,000 |
| PBB (b) | — | 200,000 | — | — | — | 350,000 | | — |
| PBA (a) | — | 100,000 | — | — | — | 200,000 | — | |

Note that in the event that two participants extend differing amounts of credit to each other, the smaller number should control and both parties will be informed of the discrepancy. In this case, CCA (b) is only willing to extend 1,500,000 contract units of credit to DDS (b) for this given transaction as opposed to the 2,000,000 contract units of credit DDS (b) is willing to extend to CCA (b).

Similarly, this patent's synthetic futures (standardization of OTC Derivatives) allows both market makers and takers to employ the Electronic Clearing Networks we see in listed securities. Something not afforded to either type of market participant (on the buyside or sellside) as OTC derivative platforms have not acted as a clearing mechanism: they could not pool liquidity as an ECN does, because each trade is an indication of interest, whereby counterparties have to confirm the details of each trade individually, once and only they have established that they have the necessary documentation to trade and settle vs. that counterparty and ample room in their credit limit to enter a new position.
1) This standardization of OTC derivatives enables multiple dealers and trading platforms to employ an Electronic Clearing Network (ECN) to match orders across various platforms and systems.
   a. As it applies to CDS, to this point nobody has employed an ECN to match bids to offers across competing platforms in these asset classes
2) Defining the delta or employing an ATM approach rather than a defined strike or price allows FX forwards and options to employ our ECN inter-platform and participant.

Collateral and Margin:
3) Collateral and Margin (or Marking to Market) may be kept in the same account allocated to a give market participant.
4) Market participant's positions and limits may be defined at the strategy, trader, Portfolio Manager, managed (or sub) account, Fund, company, or conglomerate level and may be netted at any level of this organizational hierarchy.
5) Market participants may trade these financial products on this system as either a direct dealing account or prime brokered account:
   a. There are three forms of direct dealing accounts: (1) Consortium Clearing Accounts (CCA): market makers that can trade directly on our system on their own behalf or on the behalf of their clients. (2) Direct Dealing Buyside Accounts (DDB) money managers that may enter order onto our system without the need to employ a clearing agent. (3) Direct Dealing Sellside Accounts (DDS) market making institutions that can trade only on their behalf with our system unless obligated by the triggering of a “standby agreement.”
6) DDB and DDS may employ a “standby agreement” whereby they can employ a CCA or DDS to stand between their trades and our ECN (essentially acting as a Prime Broker) in the event that the DDB or DDS cannot perform to its obligations.
7) A standby agreement may be triggered in the event of an accelerated delivery or to prevent the occurrence of accelerated delivery if sufficient funds are posted in time.
8) Open interest per account that can trade directly on our system are limited by two parameters:
   a. The size of the credit limits extended to them by other direct dealing participants
   b. The amount of collateral posted into the system.
9) When the amount of open interest is increased, cash or cash like securities are credited to the Collateral Account and from the amount devoted Margin or Marking to Market.
10) Trading may cease for a give participant (including all accounts under a given CCA) if there is a margin call at the direct dealing level.
11) Each participant may have a unique marking to market allowance before trading halts as a result of a margin call.
12) Any participant may employ a CCA to face our matching engine.
13) Participants may not be able to trade more than the collateral posted on our system.
14) The system checks a participant's credit line, and collateral/margin account versus P&L before allowing an OTC trade to be consummated between participants.
15) If the accounts/participants trade the securities off of this system they may elect to honor the trade when the participants have set up either sufficient amounts of collateral or credit lines, whichever is the limiting factor.

Select Summary of Benefits and Innovations

Pooling of liquidity between market makers, market takers, intermediaries and every permutation thereof.

A trade warehouse and OTC Matching Engine: A special purpose company (SPC) to stand between trades and participants, until delivery. This SPC acts as a central counterparty (that may temporarily stand between participants essentially warehousing trades) with which different counterparties have credit lines, so that every participant can trade against any of the other counterparties without setting up direct credit lines with those counterparties. Establishing both an allocation procedure that secures no participant will enter a trade beyond the limits extended to them by other members of the consortium.

A counterparty that if it fails, your positions are guaranteed by the other participants at the contract terms you entered the trade to be delivered vs. a counterparty that can and will honor those trades.

The mechanism of capped exposure between participants and the SPC. The look back option performing participants can exercise on non-performing participants.

The diversity benefit of accelerated delivery whereby deliver being accelerated pro rata of open interest. The delivered contract is at the rate of the last time all participants performed: eliminating both marking to market and other market losses.

Accelerated Delivery Mechanism: contracts are delivered if there is a significant change to the reference obligation, derivative or other security; delivery of contracts if the SPC cannot perform; and delivery of contracts if a participant fails.

Maximum Spread to facilitate the smooth transition between trading on spread and a running spread with points upfront for CDS contracts.

Product that allows one to trade on quoted input (spread for CDS, Vol for options, Points for FX etc), current price, or implied forward if delivery is accelerated.

Predefining the valuation methodology of a derivatives transaction, i.e. the model used, assumptions and inputs.

Introduce the concept of pre-funding collateral to establish lines of credit in the OTC market. Business as usual is to enter a trade (derivatives position) and then pledge collateral after the fact. Same day collateral pledging for new over the counter positions, not next day or an overnight wire.

Making collateral calls based on where a derivative last traded, not a theoretical model based formula.

Employing only open market “on screen” trades to determine margin, collateral, P&L and fixings

Price discovery and source of pricing for managers seeking week/month end marks. Only system of trading OTC across assetclasses that calculates collateral requirements and valuations on demand and at 15 minute intervals rather than day end or month end as is current practice.

Making an over the counter derivative the deliverable security, or the concept of making an ISDA or market equivalent trade confirmation-the reference obligation. Having investment banks take delivery of exchange-type traded product, the deliverable derivative product.

Live link or api of position, risks, p&L, collateral and margin required

Intra day marking to market, not end of day or end of month.

These synthetic futures would not have duration mismatches like current CDS contracts that are struck at different rates or trade with differing points up front. These different rates have different durations from contracts that trade purely on a running spread basis (or a future running spread basis). The contract spread is not determined until fixing, so all synthetic futures have same effective duration.

These synthetic futures would not have Delta mismatches like current options or forwards contracts that are struck at different prices. These different strikes or forward prices have different deltas from contracts that trade purely on a running delta basis (or a future running delta basis). The contract rate is not determined until fixing, so all synthetic futures have same effective delta.

Counterparty risk mitigation: Syndicate of banks can each choose how much credit they want to extend to their individual counterparties. Both buy and sellside can now face other banks and counterparties more efficiently who may have different axes than their brokers by using this platform.

Netting advantages are vastly superior to current market mechanisms. Some banks internal policies do not allow CDS contracts to be offset from a VAR standpoint unless they are struck at the same rate. These synthetic futures would perfectly net.

Collateral netting superiority to current CDS mechanics and advantages to introducing brokers are a major advantage over current system markets.

Participants can face many more counterparties though this platform rather than establishing ISDAs or other equivalent documentation and agreements with many counterparties, and individually managing risk limits, risk lines, counterparty credit exposure, collateral usage, novations and assignments, while limiting net exposure between the participant and all members of the consortium.

No need to have ISDA agreements in place. Allows for smaller funds to get up and running with less legal costs and other impediments. CCA will bear the delivery risk of those PBAs they introduce.

Macro funds, equity funds, family offices, and even retail accounts who are not necessarily involved in credit, CDS or derivatives trading could very easily and very quickly begin trading these synthetic futures through a CCA.

This patent provides a centralized marketplace where a user can go to find standing bids/offers for virtually every tradable contract. This type of centralized trading platform does not exist and consequently the market is less efficient than it needs to be right now. This advanced and efficient matching engine and trading platform will further reduce transaction cost beyond the narrower bid/ask that will emerge as a result of increased liquidity. Will become as efficient as equity markets.

Potentially reduced margin requirements for buyside accounts as the CCA will be able to pass some of their savings through to their top tier customers. Accelerated Delivery mechanism also reduces margin requirements for direct dealing accounts on both the buy and sell sides. Responsibly and safely increased leverage.

Credit lines are freed up by not having seemingly offsetting trades eating up lines. With these products, a participant can simply trade out of the position without having to enter into a counter position as one would have to in the current OTC markets. Similarly, trades that are placed in the current market to offset derivatives transactions run various basis risks including but not limited to phantom p&l caused by legacied deltas. Legacied deltas are the result of “offsetting trades” no longer being offsetting as the inputs to valuation change (when it be the value of the underlying, the risk free rate, the expected dividend/counter currency interest rate etc.).

Index Arbitrage and algorithmic trading would be much quicker, more efficient when the participants have a central source for all of their trades rather than having to probe multiple sources for bid/ask. Electronic trading, much easier for these strategies.

Structured finance applications are vast: this patent's synthetic futures on ABS, CDOs, synthetics are effective tools investment. Many are currently deterred by their lack of understanding of CDS contract nuances (fixed cap vs variable cap, implied write down, modified implied write down, shortfall compounding, etc).

These synthetic futures also provide a perfect hedge for CDO managers and underwriters. This products and matching engine are an effective tool to hedge CDO syndicate warehouse risk by shorting these synthetic futures and closing out upon deal closing. Very clean and higher correlation than shorting a generic credit or ABS index, as a participant would be shorting the specific “when issued” tranche.

Similarly, this system hedges the pipeline of Leveraged Loan/Bond syndicates more effectively by selling name specific synthetic futures than by shorting LCDS or LCDX. This trading system and products are more efficient and have fewer administrative nuisances than using CDS.

Structured finance: this system provides an unprecedented and valuable source of pricing clarity. Current systems employ dealer marks on similar contracts currently vary widely from dealer to dealer. While the marks cause valuation to vary widely, this variance is compounded by the different models participants employee to value these marks. Two of the attributes of this system is that it predefines and requires participants to adhere to a valuation model, beyond that, through standardization, valuation is determined by where a given derivative can be bought or sold—the concept of “price clearing the market”—not a theoretical level based on varying marks and differing models.

Tangible example: If Bear Stearns Asset Management had invested in these synthetic futures, their blowup would have been avoided as they would have posted margin daily since the market determines the daily closing price. Instead they relied on dealer marks which were only supplied monthly and even then were quite stale.

Trade Examples

The synthetic derivatives futures of the present invention have three basic forms:
1) Clearing trades: Trades where only the counterparty is defined at delivery, examples are CDS index trades that trade at a constant spread, or ABX and CDO tranches. Users would be employing the settlement, confirmation, transparency, accounting, valuation, and balance sheet advantages afforded by the synthetic forward. In addition it opens these relatively plain vanilla derivative asset classes to participants that cannot enter OTC derivatives without an intermediary willing to take delivery.
2) Delta Defined Derivatives: All the advantages of the “clearing trades” and the added advantage that it allows participants to hold the trades they originally entered (illustrated in the equity and fx options examples below). By trading a constant delta, participants are not as concerned with movements in the underlying security or forward value. Participants in options markets are afforded an almost pure Vega (volatility) position. When compounded, it creates a very efficient means to trade Gamma (volatility on volatility).
3) ATM: All the advantages of the “clearing trades” and the added advantage that securities that it allows participants to hold the trades they originally entered (illustrated in the CDS, FX Spot and Forward, and Equity Forward examples below). By holding the ATM position, participants have a position that is always the most liquid. Being close to the curve, costs to close or unwind trades are de minimis compared to legacied trades that are far from the current market and difficult and subsequently costly to offset in the market. By maintaining an ATM position, discrepancies in valuation are minimized compared to off market trades.
   Some derivative contracts are quoted ATM
   Marking to market is the difference between the ATM quote and the Contract rate
   By trading ATM Futures you are simply realizing the P&L that would otherwise be unrealized
   By always trading the ATM that varies with market price, your positions and costs net, not aggregate
   The liquidity ATM OTC Futures will provide is unprecedented and without parallel

These three forms of products cover the wide range of OTC Derivatives. Explained here are just the application to three asset classes to provide an example of the implementation of this patent's products and platform. Examples of CDS, FX and Equities are explained below while the implementation of this patent ranges over the full range of OTC Derivatives and other Securities.

1) CDS Trade Example:

An ATM CDS Synthetic Future (CDSF) is the obligation to buy/sell protection of a given credit on a predefined date. Of the 90 variables in a standard ISDA CDS contract for single name, all but the contract spread (contract rate) and counterparty are predefined. Index related products may have predefined spreads. When applicable, determination of the contract rate administered through an average volume at price for a set period of time during the fixing date.

Price will clear the market, everyday participants will bid for a contract struck at the previous day's close. For any given credit's maturity they will see three participant controlled variables and two variables that are not participant determined:
1) Closing Spread: The implied spread at the day's close
2) Price: Current price to purchase a contract of protection at the previous day's Closing Spread
3) Implied Spread: The Contract Spread the Price implies, this becomes the Closing Spread leading up to the delivery date and the Contract Spread on the last day of trading
4) Recovery Assumption: The first of two variables that are defined by participants through this invention. Shows the Recovery Assumption used in determining valuation of the instrument. In the event of a default. The contract is automatically novated to a clearing firm where upon the recovery assumption is mute. What survives the contract is the current market best practices. Namely that the CDS would be cash settled and recovery value will be determined by the Credit Event Fixing process administered by Creditex, Inc. (“Creditex”) and Markit Group Limited (“Markit”), in partnership with 15 major credit derivative dealers. As best practices change, so will our contract convention, but never during the term of a contract. We plan to introduce an open auction for the cheapest to deliver securities, whereby participants trade the recovery value and will have to deliver securities that meet the criteria of the ISDA confirm. Counterparties that fail to deliver said securities would trigger an event of default.
5) Swap Assumption: While there is some debate in valuing CDS using the “curve” or a “flat” interest rate model, we use a flat model and display the corresponding maturity swap rate.

The closing spread is the next day's opening spread with an opening contract value of zero. There is a set formula for valuation but price clears the market. This instrument is a near-carry-free true credit position.

For a given period leading up to the fixing day, participants can trade the near contract (front future) and the next contract. All new contract conventions will be defined before the introduction of the next contract. Upon fixing, the delivery date, participants have three choices:
1) Realize P&L: Close open position and flatten delta.
2) Trade the Roll: If long, selling the front future and buying the next contract/if short, buying the front future and selling the next contract thus maintaining a similar delta and slightly longer duration.
3) Take Delivery: Be delivered as a CDS contract facing the participating prime broker chosen by the participant to take assignments from as the platform automatically novates participants at the fixing. This maintains the participant's delta, but participants roll down the curve as you duration will decrease.

The first two market practices afford the participants to participate in the CDS markets without ever being issued a CDS contract, therefore allowing prime brokers to extend credit trading to a larger client base.

We would show the opening spread, the implied spread of bid/ask, high and low trade, volume and DVOI's of both credit and swap spreads. Each contract will open with a zero price, and cashflows will be daily from their margin account. This will solve many of the risk management, settlement and accounting issues associated with the current CDS market.

Accelerated Settlements:

If a credit defaults the obligation to enter the contract is accelerated, at that point the contract rate is defined but rendered irrelevant the counterparties as the party that is long protection receives par minus recovery.

If an entity does not post sufficient Collateral and/or Cash to cover the notional amount of outstanding positions and/or losses by 9 A.M. the next business day, the account can be frozen while any and all positions are liquidated to reduce exposure to said counterparty. This invention also offers a unique lookback option for performing counterparties participating in our matching engine. Performing Counterparties can decide, proportional to their pro-rata share of open interest (and possibly but not necessarily their eventual allocation vs. said counterparty), whether or not to accept delivery of the contract, or cancel the contract as the counterparty has not performed to their obligations.

If the Matching Engine Defaults, delivery of contracts is accelerated within the predefined trading and credit limits of the participants.

Maximum Spread:

Similar to current market convention of “Trading on Points,” the maximum spread is 500 bp. Unlike current markets, this invention offers a seamless segue between trading in points or on spread.

Index Trading:

While index trading comprises 30% of the CDS trading our index products follow the same market conventions outlined by the index originator's (CDS Index Co in the US and International Index Company in Europe). Indexes have a single blended spread from which prices are determined. In the event of a default of one or more of the individual names that index, delivery of the contract of that index is accelerated. There is never a settlement basis between the plain vanilla contracts and the deliverable product. The same methodology would apply to bespoke indexes, tranches and single name contracts after a succession event.

This system may offer multiple series of single name contracts. A series that conforms with index conventions and those that conform with single name conventions. There is not a platform that offers single names to perfectly conform to the respective index it is part of.

As an example, Citibank enters a derivatives future on 10M notional of 5 year protection of a reference obligor of the government of Brazil from the system.

Citibank's obligation is to pay daily to, or to receive from, the system, the change in value of this futures contract on the CDS. Being long the position, if the spread increases from the spread which they entered the position, they receive that.

For example, the previous day's closing spread of this CDS future was 300 basis points, the at the money spread. The 5 year protection contract is still trading at 300 basis points, and Citibank enters the trade with a futures value of value of zero.

On day 1, Brazil has negative headlines and the contract at a spread of 300 basis points is bid up to a price of 12 cents per hundred dollars, implying a closing spread of 303 (assuming every 4 cents is worth one basis point at that level).

Citibank realizes on day 1 a P&L of 0.12/100*10M, or $12,000, and is no longer long a contract at 300, but rather is long at the new at the money spread of 303.

2) Foreign Exchange Example:

For this example, we are using a USD Call/MXN Put one month 50% delta (ATM) option, though our delta defined derivatives may apply to any currency cross for both calls and puts for maturities ranging from next day out to intervals measured in years.

In the current market, when a participant would like to trade an option they query Market Makers defining the delta and maturity they wish to trade, and are either quoted a vol to trade (from which they calculate the option premium) or a premium that must be paid to enter that option.

Market Taker receives quote of 3.2% for one month 50% delta USD call/MXN Puts.

If the Market Taker chooses to enter the trade, the Market Taker and Market Maker then agree on a spot reference and the strike of the option. These numbers are determined by the market levels once they agree that the trade is done.

Market Maker and Taker agree to use 10.45 as the spot reference for USD/MXN and the strike of 11.00 for maturity 30 days later. A trade confirmation is sent from one counterparty to the other listing the trade details. Details are reviewed and amended if necessary, signed and reverted and the appropriate premium is wired by the agreed date (usually the same as the spot date for the cross).

The trade the parties enter from the moment the trade is consummated is no longer what they purchased, as spot moves then so does the delta. The next day, especially in the case of deliverable currency crosses, the trade is off market as one month options trading on the next day have a different maturity.

Collateral departments will mark the option to market, as a function of spot movements, forward movements (points), days to maturity and against a volatility curve.

Through the Delta Defined Currency Option, the participants will trade Currency Options with set delivery dates. This system of trading and settlements employs the same conventions as described in the Margin, Risk, Allocation and Settlement sections. Like the process described in the application to CDS, all details but the strike and counterparty are pre-defined. Similar to the CDS example CCA, DDB and DDS accounts would face a central counterparty until delivery. PBA would have to employ a CCA.

In this example, the delivery date of the 15^{th} of each month for contracts is assumed, though a second series of Delta Defined Currency Options will trade on a rolling basis (constant maturity) and a third as a combination of both, i.e., X days rolling until fixing date of Y. One participant is axed to buy USD Call/MXN Put one month 50% delta (ATM) options and the other is axed to sell said option. Employing any method of trading (electronic, voice brokered etc.) to enter into a Delta Defined Currency Option, the buyer will either see a price for said calls or query participants for a level to purchase said calls.

Market Taker receives a quote of 3.2% bid 3.25% offer for USD Call/MXN Put one month 50% delta (ATM) options. Market Taker lifts the offer on X contracts (size of contract is $100,000 defined by base currency). No cash is exchanged, until the end of the day mark.

This option last trades at 3.15%, providing an end of day mark. The buyer will have to pay 10 basis points of notional amount to the central clearing agent, and the Market Maker that was short the option contracts will have 10 basis points of the notional amount credited to their account. This process will continue to the delivery date of the contract.

Participants' positions in given crosses will net. A participant that buys 50, sells 30 and buys 40 will be long 60 contracts. There are no Delta or Maturity mismatches as they are constant during the life of the contract. At fixing, whether it is a weighted average at price or a snapshot of spot and forward trades entered on this platform or referencing an outside trading platform, the strike is defined according to predefined parameters outlined in a confirmation agreement and allocated amongst the risk limits mutually imposed by participants. At delivery, participants are delivered actual FX option derivative trades.

This system will not only list options struck ATM (or 50% delta), but other delta intervals as well. The products and system predefine the formulas and inputs used. Once the Spot and Forwards are defined at delivery or accelerated delivery, so are the strikes for the other Delta intervals.

Allocations at delivery described previously will apply to this asset class.

Application to Spot and Forwards:

Spot and Forwards transactions will be traded in the same manner. Spot delivery will be traded with daily delivery whereby participants can simply roll delivery to never have to take delivery of the currency cross. ATM forwards may be traded with a rolling maturity, at given date or on a combination of both to match the Options traded at specific maturities.

Spot trades' Profit and Loss is simply the change in price (expressed in counter currency) divided by that trading day's closing mark or fixing upon delivery as predefined in our confirmation agreement.

FX Forwards' Profit and Loss is calculated by taking the change in forward points and dividing that change in point by the points added to the to the Spot reference (determined by the methodology listed in the previous paragraph and predefined in the confirmation agreement).

Allocations at delivery described previously will apply to this asset class.

3) Equity Example:

This example considers a one month 50% delta (ATM) call option on the equity of Citi, though these delta defined derivatives may apply to stock for both calls and puts for maturities ranging from next day out to intervals measured in years.

In the current OTC Equity Options market, when a participant wants to trade an option, they query the Street defining the delta and maturity they wish to trade. They are then either quoted a vol to trade (from which they calculate the option premium) or premium that must be paid to enter that option. Exchange listed options are quoted in premiums for specific strikes. This patent is to establish a trade matching engine or synthetic exchange where equity options at specific deltas.

Market Taker receives a quote of 2% for one month 50% delta Citi Calls in the OTC Market. If exchange traded, the Market Taker may receive a quote of X$ for an option with Strike Z.

If the market taker chooses to enter the trade the OTC market, Market Maker and Market Taker then agree on a Spot reference and the strike of the option. Market Maker and Maker Taker agree to use 50 as the Spot reference for Citi and the strike of 52 for maturity 30 days later. A trade confirmation is sent from one counterparty to the other listing the trade details. Details are reviewed and amended if necessary, signed and reverted and the appropriate premium is wired by the agreed date (usually the same as the wire deadline for trading equities).

If the market taker chooses to enter the trade the listed options, Market Maker pays the premium to hold the option at the predefined strike if long and vice versa if short.

Traded in either manner, the trade the parties enter from the moment the trade is consummated will have a varying Delta as the price of the referenced equity moves, so does the Delta. For OTC trade equities, the next day, the trade is off market as one month options trading on the next day have a different maturity.

In trades executed OTC, collateral departments will mark the option to market, as a function of price movements in the underlying equity, movements in the risk free rate and expected dividend payments, days to maturity, and against a volatility curve. Collateral is typically only posted by the writer of the option. In the case of listed equity options, those long and short the options make margin calls as they would for a stock as a function of the parameters listed previously.

In the Delta Defined Equity Options, the participants will trade Equity Options with a set delivery date. This system of trading and settlements employs the same conventions as described in the Margin, Risk, Allocation and Settlement sections. Like the process described in the application to CDS, all details but the strike and counterparty are predefined. Similar to the CDS example CCA, DDB and DDS accounts would face a central counterparty until delivery. PBA would have to employ a CCA.

This example assumes a delivery date for our contracts are on the 15th of each month, though a second series of Delta Defined Equity Options will trade on a rolling basis (constant maturity) and a third as a combination of both, i.e., X days rolling until fixing date of Y. One participant is axed to buy one month 50% delta (ATM) Citi calls (ATM) options and the other is axed to sell said option. Employing any method of trading (electronic, voice brokered etc.) to enter into a Delta Defined Equity Option, the buyer will either see a price said calls or query participants for a level to purchase said calls.

Market Taker receives a quote of 2% bid 2.15% offer for Citi one month 50% delta (ATM) options. Market Taker lifts the offer on x contracts (size of contract is 1000 shares). No cash is exchanged, until the end of the day mark.

This option last trades at 2.35%, providing our system with an end of day mark. Buyer will have be credited 20 basis points of 1,000 (20) shares times the price of a share, to the central clearing agent, and the Market Maker that was short the option contracts will have 20 basis points of 1,000 (20) shares times the price of a share subtracted from their account. This process will continue to the delivery date of the contract.

Participants' positions in given crosses will net: A participant that buys 50, sells 30 and buys 40 will be long 60 contracts. There are no Delta or Maturity mismatches as they are constant during the life of the contract. At fixing, whether it is a weighted average at price or a snapshot of spot and forward equity trades entered through this system, or referenced via an outside trading platform, the strike is defined according to predefined parameters outlined in our confirmation agreement and allocated amongst the risk limits mutually imposed by participants. At delivery, participants are delivered actual currency option vs. predefined counterparties within predefined risk limits.

Our system will not only list options struck ATM (or 50% delta), but other delta intervals as well. As we predefine the formulas used and inputs, once the Spot and Forward are defined, so are the strikes for the other Delta intervals.

Allocations at delivery described previously will apply to this asset class.

Application to Spot, Forwards, Indexes, Bespoke Index and Variance Swaps:
Spot and Forwards transactions will be traded in the same manner. Spot delivery will be traded with daily delivery whereby participants can simply roll delivery to never have to take delivery of the referenced equity or index. ATM forwards may be traded with a rolling maturity, at given date or on a combination of both to match the Options traded at specific maturities.
Spot trades' Profit and Loss is simply the change in price defined by the trading day's closing mark or fixing upon delivery as predefined in a confirmation agreement times the notional amount of contracts.
Equity Forwards Profit and Loss is calculated by taking the change in the forward price (determined by the methodology listed in the previous paragraph and predefined in the confirmation agreement).
Indexes and Bespoke Indexes can be traded as single equities. Variance Swaps would follow the ATM approach detailed in the CDS Section.

Allocations at delivery described previously will apply to this asset class.

Settlement, Confirmation and Allocation or Delivery Procedures:

There are four types of participating accounts: CCA, DDS, DDB, & PBA

Participants would agree that provisions of our contracts would control if there is any conflict with existing agreements amongst parties. Participants would also agree to a court of law or jurisdiction to resolve any legal matters.

Terms of each deliverable contract traded would be agreed to as listed in the appendixes of the confirmation agreements.

Users of the system agree that electronic execution on our system provides a sufficient and binding form of Confirmation & Settlement.

There are four forms of Settlement: Intra-Day, Intra-Period, Fixing, and Accelerated Delivery.

Intra-Day (New Positions):

There are two forms of trading our contract electronically: From Screens and RFQ.

From Screens: A price maker has the ability to post a trade on this system specifying both price/spread and size. If a price taker enters an order that matches the already posted order, the price maker receives an electronic indication of what was done and an email.

As a price taker, you are immediately notified of your fills electronically and may elect to receive an email confirmation.

RFQ: The price taker initiates an order indication to the parties it chooses, then chooses with which price maker to execute. Both parties receive an electronic indication of the trade and may elect to receive an emailed confirm. Price makers that are not filled receive an electronic indication of nothing done. Trades that are voice brokered must be entered into the system as an RFQ (or off screen trade).

Through either electronic trading method, no cash is exchanged until the final print of the day for that position as each new trade is entered at market. Similar to other same day settle (cash) markets, each contract is assigned a closing time of 12:30 P.M. in New York, London or Tokyo (According to a defined schedule). Closing price is dictated by the last trade traded “From Screens.” Provided that a given participant has posted sufficient collateral, trading may continue after hours through the RFQ system. Trades are entered at a price (predefined assumptions listed in our Standard Formulas per asset class), the difference between the price traded and the closing price dictates the amount either credited to or debited from the participant's account with the Matching Engine. At the end of the respective trading day, the New Positions are netted and added to the Open Positions of the account.

Intra-Period (Open Positions):

The change between the opening price and closing price in a Participant's Open Positions netted vs. the New Positions will dictate the amount either credited to or debited from the participant's account with the Matching Engine and the amount of collateral required.

Sufficient amounts of collateral must be posted to the account to cover a one-day move in the contract/s traded as dictated by the participants' Collateral Matrix. If payment is not received by 6:00 P.M. of that trading day in the respective market (New York, London or Tokyo), the Matching Engine would start the failure process described later in the Accelerated Settlements section. Failures on the part of the Matching Engine or a credit event are also described in the Accelerated Settlements.

Fixing (Standard Delivery) [Also Defined in Examples Section]:

For a “Delta Defined Derivatives” and “ATM trades,” Single Name Credit, the two variables of counterparty and contract rate are defined at delivery. For “Clearing Trades” Index, Tranched Index (including both Synthetic Colateralized Debt Obligation Tranches [CDO] and Cash CDO Tranches) and Component Credits, only the counterparty is defined at delivery.

Contract Rate: For a Single Name Credit, the Contract Rates may be determined by the weighted average yield for all open market trades during a predefined two-hour fixing period. Open market trades are those posted on our screens not via confidential RFQ or voice brokered trades. When applicable contract rates may be determined using a closing level, or by a separate but similarly transparent process.

Contract Rates will be posted one hour after the fixing period ends. Indicative averages during the fixing period posted will be posted on the Internet and other electronic trading platforms are not legally binding, and just provide a rough indication of volume and price.

Counterparty: The Counterparty for an open position is set at delivery and varies by participant level as predefined below.

PBA: PBA's always face their respective CCA at delivery. The CCA is flat. The positions initiated by their PBA's as the other side of the trade will be defined in the CCA section below.

DDB: DDB's face DDS and CCA's at delivery. DDB's predefine their delivery allocations according to the credit limits extended to them by both DDS and CCA's (Pre-defined Credit Limits).

DDS: DDS take delivery of trades they initiated and those initiated by DDB's they have chosen to extend lines to.

Non-DDS initiated trades: Will fall under the Credit Limits they have extended to a DDB as defined in their credit limits.

CCA: CCA's take delivery of trades they initiated and those initiated by DDB's, DDS' and PBA's they have chosen to extend lines to.

Accelerated Settlements:

There are three circumstances that will lead to Accelerated Settlement of the Matching Engine Synthetic Futures Contacts prior to the respective Fixing Dates:
1. Credit Event of a Reference Entity [only applicable in CDS trades, though delivery of other derivatives or securities may be accelerated by a predefined qualifying change in the referenced asset]
2. Credit Event of the Matching Engine
3. Credit Even of a Participant, namely a CCA, DDS or DDB

Upon Accelerated Settlement, the affected Matching Engine Synthetic Futures Contracts will cease trading in futures form on the Matching Engine Platform and the corresponding Derivatives Contracts will be delivered to involved Participants. All Participants agree to adhere to the Accelerated Settlements conventions and the Allocation Procedures that they will be provided and administered by Matching Engine. At no point would a participant have an exposure to Matching Engine outside of the Synthetic Futures Contract, as Accelerated Settlements are subject to automatic and mandatory assignments and other forms of novation unless otherwise agreed.

1. Credit Event of a Reference Entity [unique to CDS]:

1.1. If a Reference Entity underlying one of the Matching Engine Synthetic Futures Contracts experiences a qualifying Credit Event as predefined in deliverable derivative's contract terms, delivery of the CDS Contract is accelerated. The Matching Engine Synthetic Futures Contract on that Reference Entity will cease trading and automatically convert to the corresponding CDS contract, delivered within the predefined credit limits. Participants agree to and are obligated to enter into the corresponding CDS Contract [no longer facing Matching Engine.]

For CDS Synthetic Futures Contracts involving more than one Reference Entity (index, tranched index or single name post ISDA defined event of succession), Matching Engine may reopen that contract adjusted for the subsequent reweighting.

For Single Reference Entity Contracts: Participants that have previously entered into Matching Engine Synthetic Futures Contracts referencing the affected Reference Entity will immediately enter into CDS Contracts on that Reference Entity in Notional Amounts equal to the Notional Amounts of their Matching Engine Synthetic Futures Contracts. Participants agree to enter into CDS Contracts facing any other Participant, in accordance with their predefined Counterparty Exposure Limits. Since Matching Engine will never maintain any net exposure to a Reference Entity, all CDS Contracts will be novated such that Participants will face other Participants directly. The Matching Engine will cease to be a Counterparty to any Futures Contract or CDS Contract that is subject to Accelerated Settlement under this clause 1.1. Unless otherwise agreed.

1.2. The CDS Contract Rate for each Reference Entity will be determined according to the Accelerated Settlement CDS Contract Rate Formula. The Accelerated Settlement CDS Contract Rate Formula will reference the previous day's closing level of each Matching Engine Synthetic Futures Contract prior to the Reference Entity experiencing a Credit Event. In the event that the CDS closed at a predefined Maximum Spread, the Maximum Spread will define the contract rate.

1.3. Since all Participants will have posted the appropriate amount of Margin for their positions prior to the Credit Event, there will be no additional Margin requirements upon Accelerated Settlement, beyond those owed Intra-Day and Intra-Period as defined above. Further, once the CDS Contracts have been assigned between the Participants, all Margin and other forms of collateral posted against affected Matching Engine Synthetic Futures Contracts will be credited back the affected Participants Margin Accounts.

2. Credit Event of the Matching Engine:

2.1. In the event that the Matching Engine experiences a Credit Event or otherwise loses the ability to conduct its normal course of business, all outstanding Matching Engine Synthetic Futures Contracts will cease trading and will enter Accelerated Settlement. No new Matching Engine Synthetic Futures Contracts will be created after Matching Engine experiences a Credit Event. Participants agree to adhere to the Accelerated Settlement procedures outlined in Sections 1.1 and 1.2, whereby all Synthetic Futures Contracts are converted to Derivatives Contracts.

2.2. The Derivatives Contract Rate for each Synthetic forward will be determined according to the Respective Accelerated Settlement Contract Rate Formula. The Accelerated Settlement Contract Rate Formulas will reference the previous day's closing level of each Matching Engine Synthetic Futures Contract prior to the Matching Engine experiencing a qualifying event of default. [The contract rate does not determine value as does the marking to market and Participants are further protected as the Matching Engine platform trades what participants would bid of ask for a contract struck at the previous day's close.]

2.3. Upon successful assignment of all Contracts to Participants, all Margin previously posted to the Matching Engine will be returned to Participants.

3. Credit Event of a Participant, Failure Process

3.1. If a Consortium Clearing Account (CCA) or Direct Dealing Sellside Account (DDS) experiences a Credit Event (Failing Party) or fails to post sufficient funds as described in the Intra-Day or Intra-Period settlement process described above, they will be subject to identical remedy mechanisms. The Surviving Participants will be informed of their pro-rata portion of open interest that has failed. Surviving Participants holding the other side of the Failing Party's contracts, will have the choice to either enter into the contract or cancel the contract on a credit per credit basis:

1) Enter into the corresponding derivatives contracts directly with the Failing Counterparty adhering to the Accelerated Settlement mechanism described in Section 2, or

2) Cancel the corresponding Matching Engine Synthetic Futures Contracts at the previous day's closing price.

3.2. If the Surviving Participant elects to cancel the Matching Engine Synthetic Futures Contracts pursuant to Section 3.1, it shall no longer have any responsibility to Matching Engine or any other Participant for the cancelled contracts. The Surviving Participant may then access the Matching Engine Platform to enter into a new Matching Engine Synthetic Futures Contract to replace the cancelled Matching Engine Synthetic Futures Contract if it so desires.

3.3. If a Prime Brokerage Account (PBA) experiences a Credit Event, there will be no Accelerated Settlements for any of their contracts solely as a result of their failure. The CCA through which the failed PBA clears is responsible to the Consortium for all of the PBA's contracts.

3.4. If a Direct Dealing Buyside Account (DDB) experiences a Credit Event, the Standby Counterparty who has extended credit to the failed DDB will assume the roll of a Failing Party and will be subject to the remedies provided for in Section 3.1. Consequently, each Standby Counterparty (whether participating solely as a Standby Counterparty or also as a DDS) shall agree not to extend credit to DDBs that in aggregate exceeds the aggregate amount of credit extended to that Standby Counterparty by the Consortium.

3.5. In the event that multiple Participants fail simultaneously, all Synthetic Futures Contracts in which the failing Participants have taken Offsetting Positions will be cancelled as if they had never existed. Any remaining Synthetic Futures Contracts of the Failing Participants in the system will be subject to the other remedies provided for in this Section 3, thus minimizing the affect to other participants.

4. Allocation Procedure

4.1. In order to facilitate the Allocation Procedure upon Accelerated Settlement, all Participants (without regard to whether they maintained a position in an affected Reference Entity) agree to accept novation of an Offsetting Derivatives Position facing any other Participant, in accordance with predefined Counterparty Exposure Limits with the sole provision that their delta remains unchanged through the delivery process (as predefined and listed below).

Allocation at Delivery:

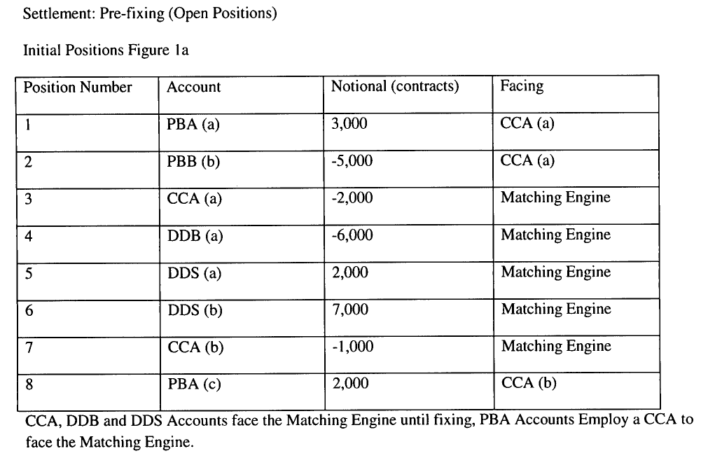

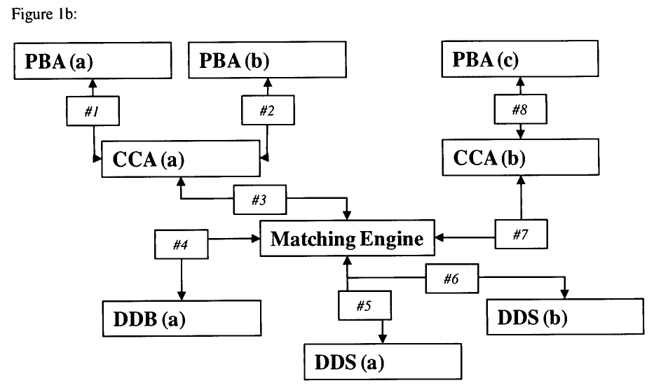

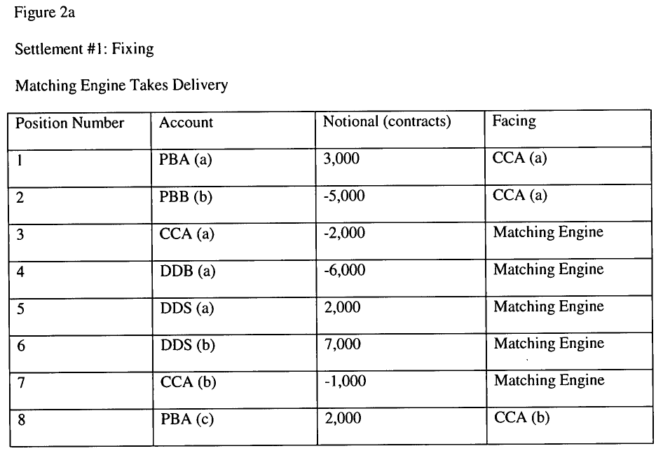

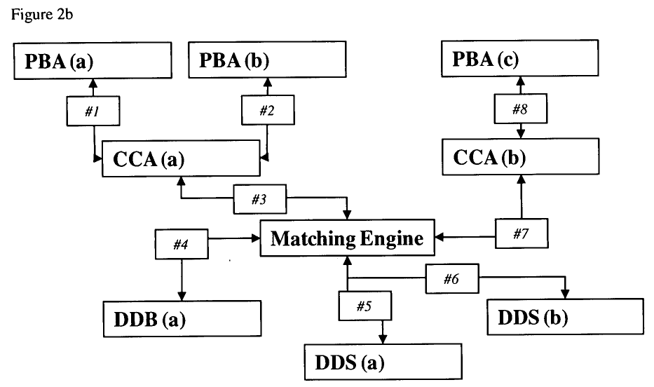

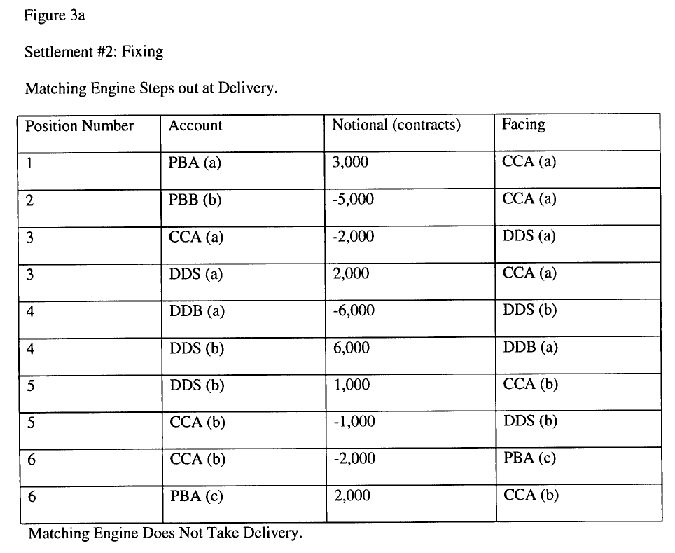

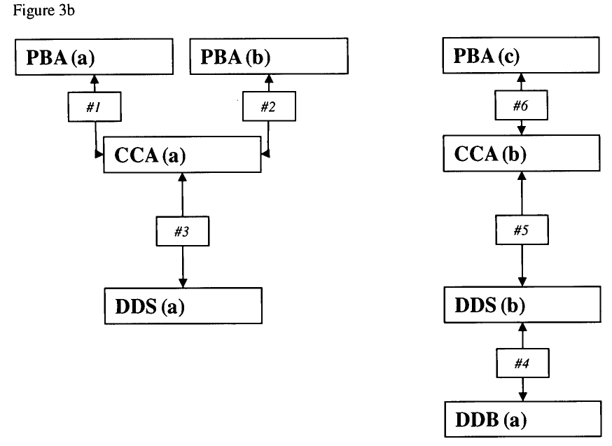

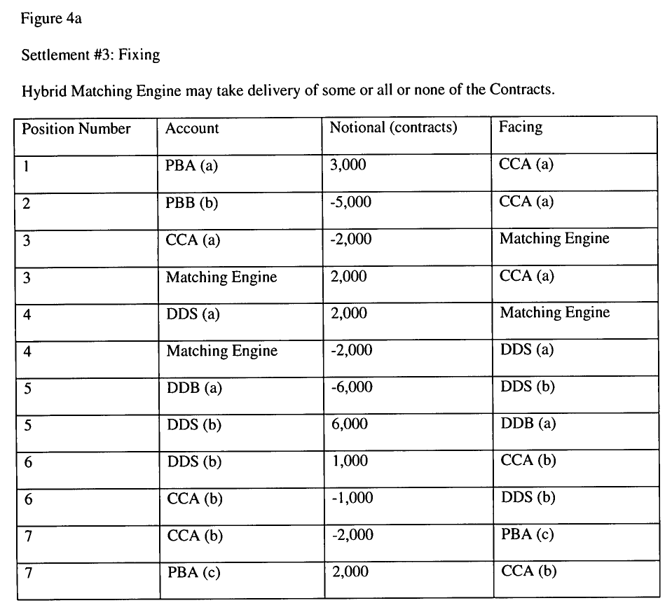

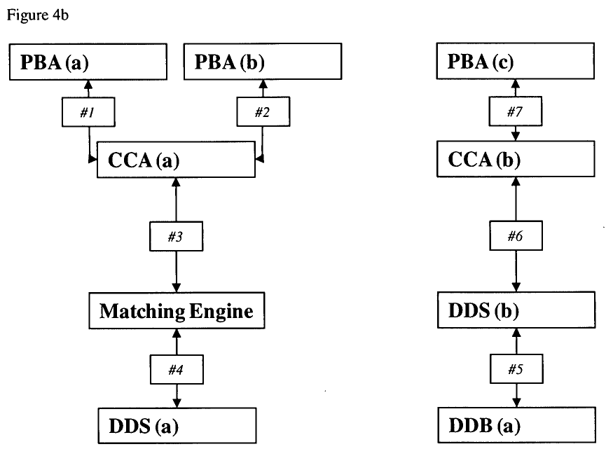

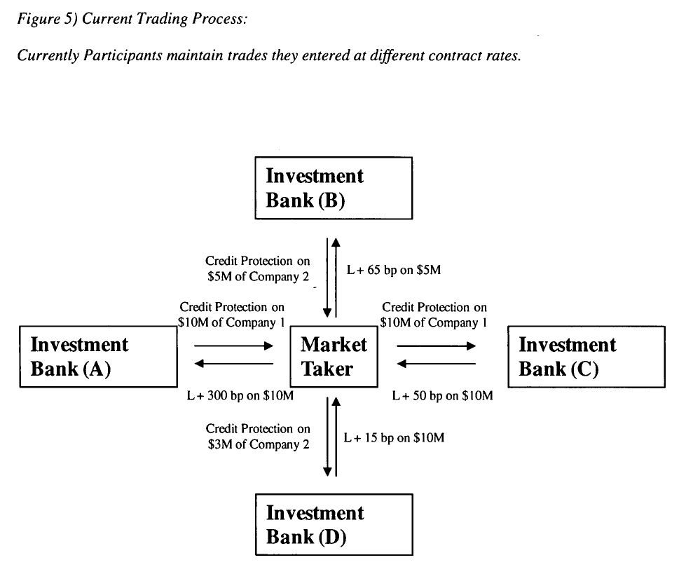

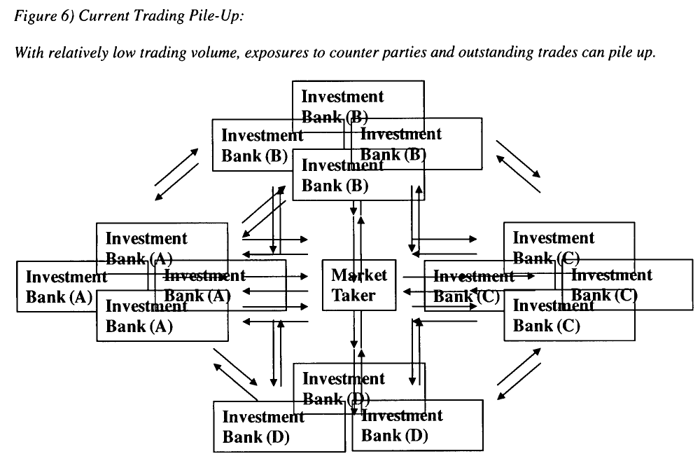

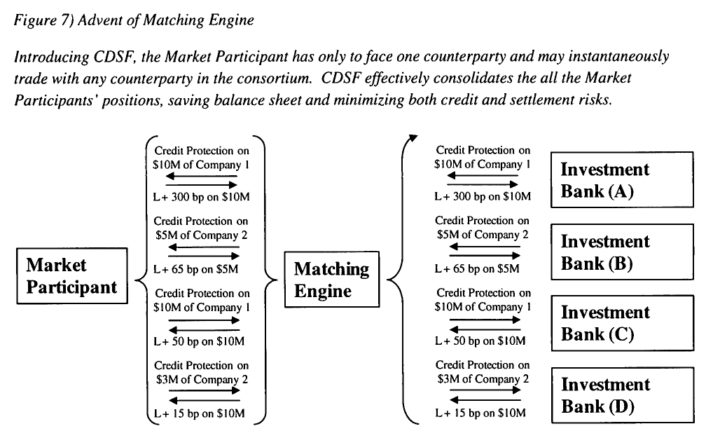

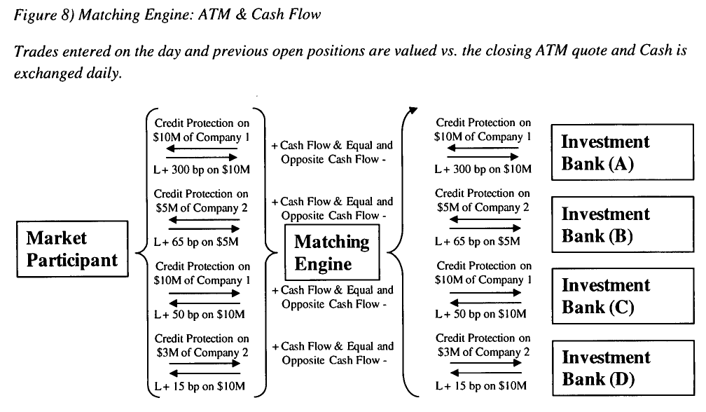

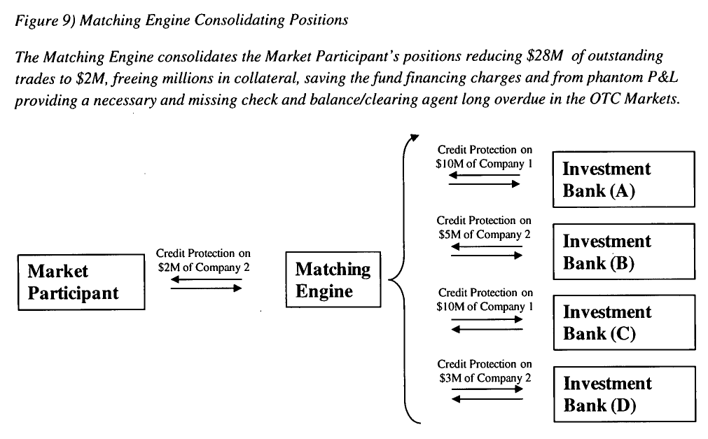

At delivery of the derivatives transaction, the Matching Engine, may continue to face counterparties, step out of the trades or a combination of both. Please refer to the following four charts and diagrams illustrated in FIGS. 1-9.

What is claimed is:

1. A method for trading futures on financial products comprising:
defining a reference financial product and providing a contract rate;
accepting a trade from a first party on a future where the deliverable is the reference financial product at the contract rate;
allocating a change in value of the future to the first party; and
resetting the contract rate for the first party as a function of the change in value.

2. The method as recited in claim 1 wherein the future is a CDS contract.

3. The method as recited in claim 1 wherein the contract rate is a spread, forward points, or price.

4. A method for trading futures on financial products comprising:
defining a reference financial product having and providing a delta at a predetermined level;
accepting a trade from a first party on a future where the deliverable is the reference financial product at the delta;
allocating a change in value of the future to the first party; and
resetting the price of the future for the first party as a function of the change in value.

5. A trading platform comprising:
a system for trading futures based on OTC derivatives; and
stands between counterparties warehousing trades and managing collateral until delivery of the futures whether accelerated or scheduled.

6. A financial product comprising;
a future based on an OTC derivate.
